(19) United States
(12) Patent Application Publication
(10) Pub. No.: US 2014/0343487 A1
(43) Pub. Date: Nov. 20, 2014

(54) Drinking straw that contains substances for treating the side effects of alcohol consumption

(71) Applicant: Semion Hlebnikov, Tel Aviv (IL)

(72) Inventor: Semion Hlebnikov, Tel Aviv (IL)

(21) Appl. No.: 13/893,385

(22) Filed: May 14, 2013

(51) Int. Cl. A61J 7/00

(52) U.S. Cl. CPC A61J 7/0038
USPC 604/77

(57) ABSTRACT

A drinking straw that contains an alcohol treatment substance such that the user consumes the alcohol treatment substance while drinking the alcoholic beverage using the drinking straw. The drinking straw may include a perforated top barrier and a perforated bottom barrier with an alcohol treatment substance in between or may have a perforated capsule containing an alcohol treatment substance in it or attached to its bottom opening.

### TECHNICAL FIELD

The present invention refers to a drinking straw that contains substances for treating the side effects of alcohol consumption and other special materials.

### BACKGROUND ART

The consumption of alcohol is accompanied by many side effects such as hangover, and liver damage (hereinafter referred to as “alcohol consumption side effects”). Preparations have been developed to treat and prevent such side effects which users may take before, during or after consuming alcohol (hereinafter referred to as “alcohol treatment substances”). It is presently customary to give alcohol treatment substances in the form of pills, powders or liquids. The present invention enables the user to take alcohol treatment substances using the drinking straw used to consume the alcoholic beverage.

### LIST OF THE DRAWINGS

FIG. 1 depicts the drinking straw (1) with perforated (31) top and bottom barriers (3) and an alcohol treatment substance (2) in between.

FIG. 2 depicts a perforated (41) capsule (4) that contains an alcohol treatment substance (2).

FIG. 3 depicts a drinking straw (1) with a capsule (4) inside it.

FIGS. 4 and 5 depict a drinking straw (1) with a capsule (4) attached to its bottom.

FIG. 6 depicts the bottom of drinking straw (1) with the said bottom barrier (3).

FIG. 7 depicts the bottom of drinking straw (1) with the said bottom barrier (3).

FIG. 8 depicts the bottom of drinking straw (1) with the said bottom barrier (3).

FIG. 9 depicts the drinking straw (1) with blocked top (71) and bottom inlet (72) whereby liquid flows in and out of the drinking straw (1) through the perforations (73).

FIG. 10 depicts the drinking straw (1) with material (5) and therapeutic' minerals (6).

### THE INVENTION

The object of the present invention is to provide a drinking straw that contains alcohol treatment substances such that the user takes the alcohol treatment substances while drinking the alcoholic beverage using the said drinking straw.

The drinking straw (1), subject of the present invention, is in fact a standard drinking straw intended for the consumption of liquids, that contains an alcohol treatment substance (2). While the user drinking the alcoholic beverage, the alcohol treatment substance dissolves and is consumed by the user along with the beverage.

The alcohol treatment substance (2) can be incorporated into the drinking straw (1) in several possible ways as described below, although the invention and patent application cover and refer to all manners and ways in which the alcohol treatment substance (2) can be incorporated into the drinking straw (1). The alcohol treatment substance (2) can incorporated into the drinking straw (1) as a powder, as a solid in the form of a tablet for example, in crystalline or liquid form, and so on, all according to the kind of substance and the desired duration of its dissolution and/or consumption by the user. In any case, the design must take into consideration that the alcohol treatment substance is supposed to be dissolved in and/or diluted by the alcoholic beverage consumed by the user.

In the first embodiment of the invention, the alcohol treatment substance (2) is applied to the inner surface of the drinking straw (1).

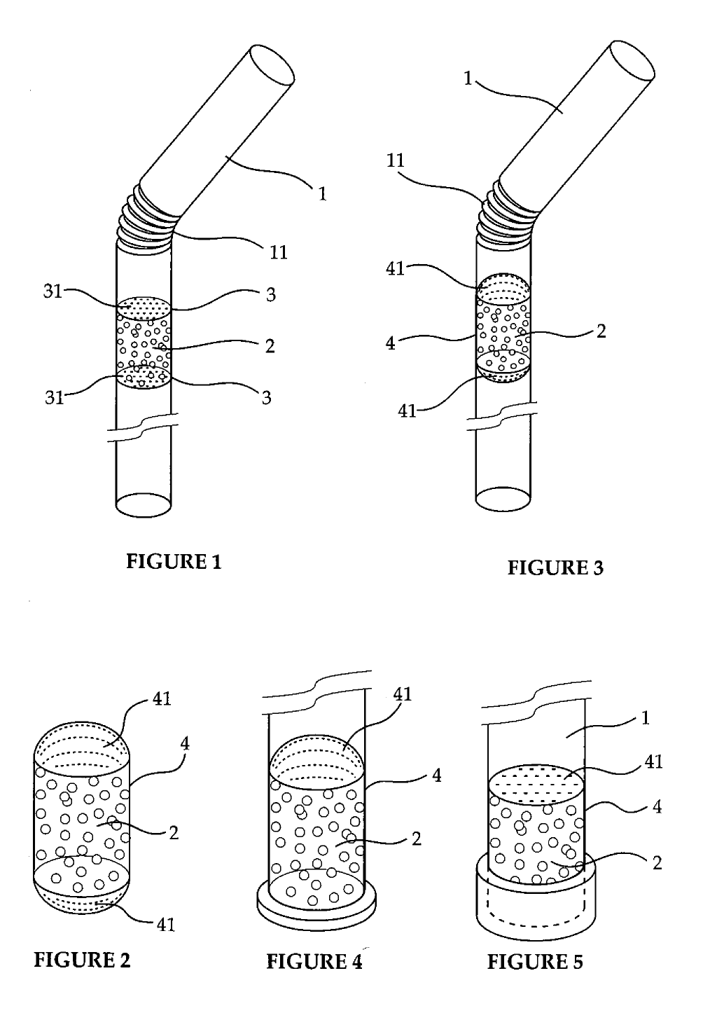

In the second embodiment of the invention, the alcohol treatment substance (2) is contained in the drinking straw (1) between two perforated barriers (3) positioned above and below the alcohol treatment substance. The perforations (31) in the barriers (3) enable the liquid to flow from the beverage glass to the user's mouth. The barriers (3) can be designed in a variety of ways and can be shaped like flat discs, plastic spheres -beads, and so on. The external diameter of the bathers (3) should be slightly smaller, preferably 0.5 mm. smaller, than the inner diameter of the drinking straw (1) so as to enable the barriers (3) to be inserted into the drinking straw (1), on the one hand, and to stay fixed to the inside of the drinking straw (1) without falling out into the beverage glass through the bottom opening of the drinking straw (1), on the other hand. This will also prevent the barriers (3) from entering the user's mouth since they will be stopped at the bend area (11) of the drinking straw (1) due to their size. FIG. 1 depicts the drinking straw with a perforated top barrier (3) and a perforated bottom barrier (3) and an alcohol treatment substance (2) in between. The distance between the two barriers (3) can vary and can extend practically the entire length of the drinking straw (1).

In the third embodiment of the invention, the alcohol treatment substance (2) is concealed in a capsule (4) with perforations (41) on either side such that the alcoholic beverage can pass through the capsule. FIG. 2 depicts the capsule. The capsule is concealed in the inner part of the drinking straw (1), as depicted for instance in FIG. 3. The exterior diameter of the capsule (4) should be about the same as the external diameter of the barrier (3), for the aforementioned reasons. When the capsule (4) itself is made of a soluble material, as are capsules used to administer antibiotics, a barrier (3) with perforations (31) may be inserted above the capsule to prevent pieces of the capsule (4) from entering the user's mouth. The capsule (4) may also be made of a soluble material that contains the alcohol treatment substance (2) in liquid form.

In the fourth embodiment of the invention, the alcohol treatment substance (2) is contained in a capsule (4) that is fixed to the bottom of the drinking straw (1). FIGS. 4 and 5 depicts the bottom of the drinking straw (1) with a perforated (41) capsule (4) containing an alcohol treatment substance (2) that is fixed to the bottom of the drinking straw (1).

The manners in which the alcohol treatment substances (2) are concealed in the drinking straw (1), as described in the present invention, enable to manufacture the drinking straw (1) in an inexpensive and efficient manner, without requiring any special, expensive or complex machinery and at relatively low production cost.

The drinking straw (1), subject of the present invention, offers many advantages since establishments that serve alcoholic beverages can keep them in stock and their use can help create a more minded drinking culture so that when alcoholic beverages are served, drinking straws (1) containing alcohol treatment substances (2), subject of the present invention, will be served with them.

It is further emphasized that each drinking straw (1) can contain a variety of active substances and/or several capsules (4) each of which contains a different substance intended to treat a different problem. It is also noted that when the capsule (4) and/or the alcohol treatment substance (2) are located in the upper part of the drinking straw (1), the alcohol treatment substance (2) is dissolved only when the beverage actually flows through the alcohol treatment substance (2), or in other words, when the alcoholic beverage is actually consumed. On the other hand, when the capsule (4) and/or the alcohol treatment substance (2) are located in the bottom part of the drinking straw (1), the alcohol treatment substance (2) will dissolve into the alcoholic drink even when the drinking straw (1) is merely placed in the glass and not only when the user actually drinks the beverage.

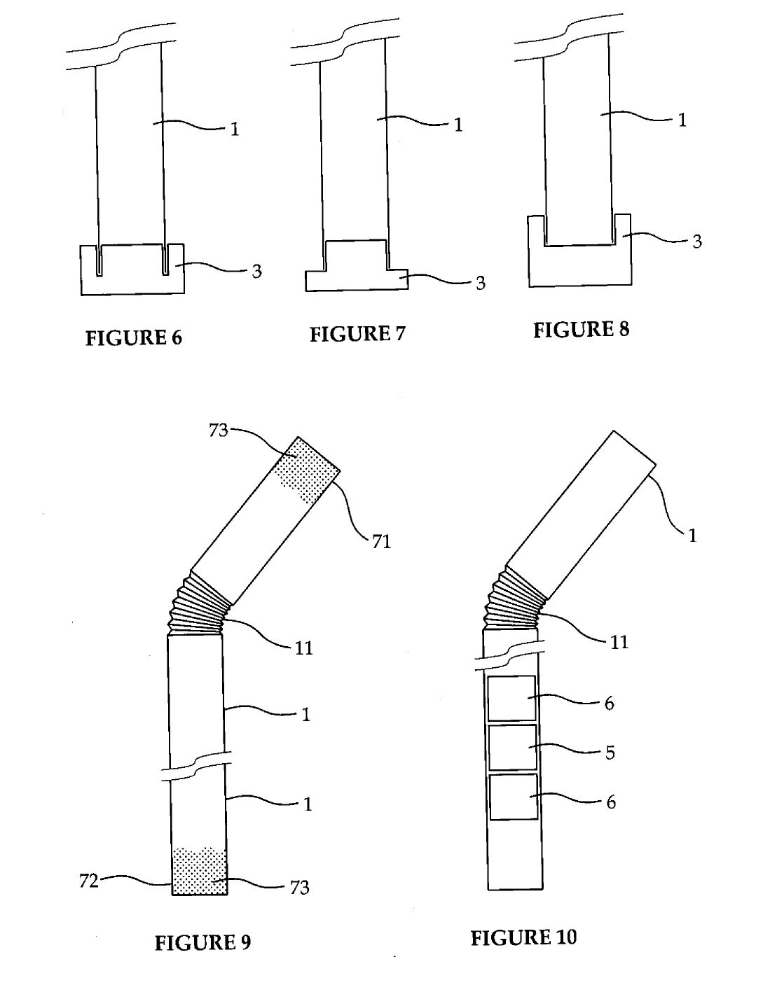

The fifth embodiment of the invention refers to a drinking straw (1) that contains alcohol treatment substances (2) and has a bottom barrier (3) at the bottom of the drinking straw (1) that can be removed so as to enable the user to remove the alcohol treatment substances (2) from the drinking straw (1) and consume them directly. This version of the drinking straw (1) is used in cases in which the user wishes to consume the alcohol treatment substances (2) without drinking a beverage using the drinking straw (1). The bottom bather (3) may screw into the drinking straw (1) or be attached using pressure, or any other suitable method. FIGS. 6-8 depict the bottom of the drinking straw (1) with the said bottom barrier (3).

The sixth embodiment of the invention refers to a drinking straw (1) that contains an alcohol treatment substance (2) such that the bottom or upper barrier (3) or the capsule (4) or a piece of material (5) inserted into the drinking straw (1) is made of a substance, ceramic, plastic, etc., that contains therapeutic minerals (6). Therapeutic minerals (6) are minerals that are customarily attributed with properties that, among other things, enrich and improve liquids they come in contact with. Such properties include active hydrogen content, far infrared rays, alkaline balance, negative ions, low ORP values, small molecules. A variety of products are currently available on the market that contain therapeutic minerals (6) which include, among others, the following elements and compounds: tourmaline, zeolite, germanium, magnesium, neodymium, Maifan Stone, fir, lava minerals, bimesste, calcium, and zinc. Thus, using the drinking straw (1) improves the liquid flowing through it as it comes in contact with the therapeutic minerals (6).

The seventh embodiment of the invention refers to the drinking straw (1) subject of the sixth embodiment but which does not necessarily contain any alcohol treatment substances (2).

The eighth embodiment of the invention refers to a drinking straw (1) that contains alcohol treatment substances (2) or therapeutic minerals (6) and whose outlet (71) and inlet (72) are blocked, by means of heat or pressure for instance. Perforations (73) around the top outlet (71) and bottom inlet (72) of the drinking straw (1) enable liquid to flow in and out of the drinking straw (1), as depicted in FIG. 9.

The ninth embodiment of the invention refers to a drinking straw (1) that contains a capsule (4) or piece of material (5) made of a ceramic material, plastic, etc., that contains therapeutic minerals (6) and has a diameter that corresponds with the inner diameter of the drinking straw (1). The capsule (4) or piece of material (5) is inserted into the drinking straw (1) in such a way that it cannot fall out through the bottom nor be sucked up through the top. The drinking straw (1) may also have a bend area (11) that prevents the capsule (4) or piece of material (5) from being sucked up and out through the top of the drinking straw (1), as depicted for instance in FIG. 10.

FIG. 9 depicts the drinking straw (1) with blocked top (71) and bottom inlet (72) whereby liquid flows in and out of the drinking straw (1) through the perforations (73).

Nine versions of the straw (1) that contains substances for treating the side effects of alcohol consumption (2), or other therapeutic substances, are described above. The invention may be implemented to manufacture straws (1) in any of the versions mentioned in the patent application and in the first supplement whereby the straw (1) contains a substance that imparts energy (hereinafter “energy supplement”), anti-depressant or substances based on legal drugs. Thus, any use of the expression “substances for treating the side effects of alcohol consumption” or “therapeutic substance” or “substance” in the above description and in the Claims section refers also to an energy supplement, anti-depressant or substances based on legal drugs.

The straw (1) in each of the nine aforementioned versions, which contains an energy supplement, anti-depressant or substances based on legal drugs is also designed both to solve a severe problem experienced by alcohol consumers and to provide sensual enjoyment that the general public yearns for.

Energy supplements and anti-depressants: It is common knowledge that the consumption of alcohol causes drowsiness during and after drinking as well as the following morning. Alcohol consumption also causes a certain level of depression after drinking and, in many cases, the following morning as well. Using a straw (1) that contains energy supplements or anti-depressants, subject of the present invention, solves these problems.

Legal drugs are known by the name “party pills” and their use is both widespread and legal. Legal drugs, which include a wide variety of substances that any professional in the field is familiar with, have various effects such as enhanced mood, euphoria, ecstasy, enhanced alertness and arousal, tranquility, stream of consciousness bordering with hallucination, sexual arousal, and enhanced stamina and energy. Using the straw (1) that contains substances based on legal drugs enables the user to consume such substances while drinking, and at the rate of drinking.

The straw (1), including all nine version described above and the aforementioned variety of substances, can also be used when drinking non-alcoholic beverages.

The said energy supplements, anti-depressants and substances based on legal drug are all substances that are legal and allowed for human consumption. These substances are familiar to any expert professional in the field and do not require any further elaboration in addition to that specified above.

What is claimed is:

1. A drinking straw that contains alcohol treatment substance such that the user consumes the alcohol treatment substance while drinking the alcoholic beverage using the said drinking straw.

2. The drinking straw mentioned in claim No. 1 whereby it has a top barrier, with one or more perforations, and a bottom barrier, with one or more perforations, and whereby the alcohol treatment substance is located in between these two barriers.

3. The drinking straw mentioned in claim No. 1 whereby it contains a perforated capsule that contains the alcohol treatment substance.

4. The drinking straw mentioned in claim No. 1 whereby a perforated capsule containing the alcohol treatment substance is attached to the bottom of the drinking straw.

5. The drinking straw mentioned in claim No. 2 whereby the bottom barrier may be removed and re-inserted.

6. The drinking straw mentioned in claim No. 2 whereby the bottom barrier or top barrier or capsule or piece of material inserted into the drinking straw is made of a material that contains therapeutic minerals.

7. The drinking straw mentioned in claim No. 6 whereby the therapeutic minerals belong to the group of minerals commonly attributed with properties that enrich and improve liquids they come in contact with, such as, but not limited to, tourmaline, zeolite, germanium, magnesium, neodymium, Maifan Stone, fir, lava minerals, bimesste, calcium, and zinc.

8. The drinking straw mentioned in claim No. 6 whereby it does not necessarily contain any alcohol treatment substances.

9. A drinking straw that contains alcohol treatment substances such that the user consumes the alcohol treatment substances while drinking the alcoholic beverage using the said drinking straw but whereby the inlet and outlet of the drinking straw are blocked and there are several perforations around the circumference of the bottom and top of the drinking straw through which the liquid flows in and out of the drinking straw.

10. A drinking straw that contains therapeutic minerals whereby the inlet and outlet of the drinking straw are blocked and there are several perforations around the circumference of the bottom and top of the drinking straw through which the liquid flows in and out of the drinking straw.

11. A drinking straw that contains a capsule or a piece of material made of a material that contains therapeutic minerals, whose diameter corresponds with the inner diameter of the drinking straw, and which is inserted into the drinking straw in a way that prevents it from falling out (through the bottom inlet) or being sucked up and out (through the top outlet).
